(19) United States
(12) Patent Application Publication
(10) Pub. No.: US 2026/0018915 A1
(43) Pub. Date: Jan. 15, 2026

(54) ELECTRONIC SYSTEM AND METHOD FOR CONTROLLING THE SAME

(71) Applicant: AAC ACOUSTIC TECHNOLOGIES (SHENZHEN) CO., LTD., Shenzhen (CN)

(72) Inventors: Chuncheng Yang, Shenzhen (CN); Hongyan Tao, Shenzhen (CN)

(21) Appl. No.: 19/169,018

(22) Filed: Apr. 3, 2025

Related U.S. Application Data
(63) Continuation of application No. PCT/CN2024/104912, filed on Jul. 11, 2024.

(51) Int. Cl. H02J 7/00

(52) U.S. Cl. CPC H02J 7/007; H02J 7/00034; H02J 7/0029; H02J 7/0068

(57) ABSTRACT

Provided are an electronic system and a method for controlling the same. The electronic system includes an electronic device at least including: a charging circuit having a first input terminal, a second input terminal, and a first output terminal, and including a first transistor, a second transistor, a third transistor, and a fourth transistor; a switching circuit including an input terminal connected to the first output terminal and an output terminal connected to a power supply of the electronic device and configured to connect or disconnect a connection path between the first output terminal and the power supply; and a communication device, which, in a communication mode, is connected to the first and second input terminals to communicate with the electronic device through the first and second input terminals. The implementation of the present disclosure is at least conducive to prolonging the service life of the electronic device.

### TECHNICAL FIELD

The present disclosure relates to the technical field of electronic circuits, and in particular, to an electronic system and a method for controlling the same.

### BACKGROUND

Portable electronic devices include Bluetooth earphones, Bluetooth smart glasses, and other products. At present, the ways of charging the portable electronic devices are as follows: for True Wireless Stereo (TWS) earphones and Open Wireless Stereo (OWS) earphones, they each are typically equipped with a charging box having a charging bin. When charging the earphones, it is necessary to charge the charging box by connecting a Universal Serial Bus (USB) cable to a power adapter, then the earphones placed in the charging bin and the charging box are docked for charging through POGO PINs, and the earphones are charged through the charging box; and for Bluetooth smart glasses, they are generally charged through a charging cable with charging management, one end of the charging cable is connected with a power supply, the other end of the charging cable has two charging bases diverged therefrom, and the two charging bases are each connected to a respective one of the eyeglass temples, thereby charging the Bluetooth smart glasses.

However, when an earphone is placed into the charging bin, the earphone may be reversely placed due to some charging bin designs, thereby causing a positive charging interface and a negative charging interface of the earphone to be reversely connected to the two output interfaces of the charging box, thus causing a short circuit, affecting the service life of the earphone and even damaging the product, and causing the battery of the earphone to catch fire in serious cases. The same problem also exists in the connection between the eyeglass temples of the Bluetooth smart glasses and the charging cable. Therefore, the current ways of charging the portable electronic devices need to be improved.

### SUMMARY

Embodiments of the present disclosure provide an electronic system and a method for controlling the same, which are at least conducive to prolonging the service life of an electronic device.

An aspect of the embodiments of the present disclosure provides an electronic system including: an electronic device at least including: a charging circuit having a first input terminal, a second input terminal, and a first output terminal, and including a first transistor, a second transistor, a third transistor, and a fourth transistor, where a source of the first transistor is connected to a source of the third transistor, the source of the first transistor is connected to ground, a gate of the first transistor is connected to a gate of the second transistor, a drain of the first transistor is connected to a drain of the second transistor, the drain of the first transistor serves as the first input terminal, a source of the second transistor is connected to a source of the fourth transistor, the source of the second transistor serves as the first output terminal, a drain of the third transistor is connected to a drain of the fourth transistor, the drain of the third transistor serves as the second input terminal, a gate of the third transistor is connected to a gate of the fourth transistor, the gate of the third transistor is connected to the first input terminal, and the gate of the first transistor is connected to the second input terminal; and a switching circuit having an input terminal connected to the first output terminal and an output terminal connected to a power supply of the electronic device, where the switching circuit is configured to connect or disconnect a connection path between the first output terminal and the power supply; where during a period in which the switching circuit connects the connection path between the first output terminal and the power supply, the electronic device is in a charging mode, and during a period in which the switching circuit disconnects the connection path between the first output terminal and the power supply, the electronic device is in a communication mode; and where in the communication mode, a communication device is connected to the first input terminal and the second input terminal to communicate with the electronic device through the first input terminal or the second input terminal.

As an improvement, the electronic device further includes a main control module at least including a first enable terminal; where the switching circuit includes a fifth transistor, a gate of the fifth transistor is connected to the first enable terminal, a source of the fifth transistor serves as the input terminal of the switching circuit, and a drain of the fifth transistor serves as the output terminal of the switching circuit; and where during a period in which the gate of the fifth transistor receives a first enable signal sent from the first enable terminal, the fifth transistor is in a turned-on state, and during a period in which the gate of the fifth transistor does not receive the first enable signal sent from the first enable terminal, the fifth transistor is in a turned-off state.

As an improvement, the switching circuit further includes a first resistor, and the gate of the fifth transistor is connected to the first enable terminal through the first resistor.

As an improvement, the electronic device further includes a main control module; where the main control module at least has a second enable terminal, a third enable terminal, a first detection terminal, a second detection terminal, and a third detection terminal, the first detection terminal is connected to the first input terminal, the second detection terminal is connected to the second input terminal, and the third detection terminal is connected to the first output terminal; where the electronic device further includes a communication control circuit having a second output terminal and a third output terminal, and the communication control includes: a sixth transistor, where a source of the sixth transistor serves as the second output terminal, a drain of the sixth transistor is connected to the first input terminal, and a gate of the sixth transistor is connected to the second enable terminal; and a seventh transistor, where a source of the seventh transistor serves as the third output terminal, a drain of the seventh transistor is connected to the second input terminal, and a gate of the seventh transistor is connected to the third enable terminal; and where when the third detection terminal receives a communication signal sent from the first output terminal, the main control module controls the sixth transistor to be turned on or off according to a signal received by the first detection terminal, and controls the seventh transistor to be turned on or off according to a signal received by the second detection terminal.

As an improvement, one of the first input terminal or the second input terminal sends a first signal to the main control module through a respective detection terminal at a same moment; during a period in which the first detection terminal receives the first signal sent from the first input terminal, the main control module sends a second enable signal from the second enable terminal, and during a period in which the gate of the sixth transistor receives the second enable signal, the sixth transistor is in a turned-on state, and the second output terminal is connected to the first input terminal to enable communication between the communication device and the electronic device; during a period in which the second detection terminal receives the first signal sent from the second input terminal, the main control module sends a third enable signal from the third enable terminal, and during a period in which the gate of the seventh transistor receives the third enable signal, the seventh transistor is in a turned-on state, and the third output terminal is connected to the second input terminal to enable the communication between the communication device and the electronic device; and during a period in which the gate of the sixth transistor does not receive the second enable signal, the sixth transistor is in a turned-off state, and during a period in which the gate of the seventh transistor does not receive the third enable signal, the seventh transistor is in a turned-off state.

As an improvement, the electronic device further includes a second resistor, a third resistor, a fourth resistor, and a fifth resistor, where the first detection terminal is connected to the first input terminal through the second resistor, one terminal of the third resistor is connected to the first detection terminal, and the other terminal of the third resistor is connected to the ground; and where the second detection terminal is connected to the second input terminal through the fourth resistor, one terminal of the fifth resistor is connected to the second detection terminal, and the other terminal of the fifth resistor is connected to the ground.

As an improvement, the electronic device further includes a sixth resistor, a seventh resistor, an eighth resistor, and a ninth resistor, where the gate of the sixth transistor is connected to the second enable terminal through the sixth resistor, one terminal of the seventh resistor is connected to the gate of the sixth transistor, and the other terminal of the seventh resistor is connected to the ground; and where the gate of the seventh transistor is connected to the third enable terminal through the eighth resistor, one terminal of the ninth resistor is connected to the gate of the seventh transistor, and the other terminal of the ninth resistor is connected to the ground.

As an improvement, the communication control circuit further includes a tenth resistor, an eleventh resistor, and a twelfth resistor, a first terminal of the tenth resistor is connected to the first output terminal, a first terminal of the eleventh resistor is connected to a second terminal of the tenth resistor, a second terminal of the eleventh resistor is connected to a first terminal of the twelfth resistor, a second terminal of the twelfth resistor is connected to the ground, the second terminal of the eleventh resistor is connected to the third detection terminal, and the first output terminal is connected to the third detection terminal through the tenth resistor and the eleventh resistor.

As an improvement, the sixth transistor and the seventh transistor are both N-channel metal oxide semiconductor (NMOS) transistors.

As an improvement, the first transistor and the third transistor are both NMOS transistors, and the second transistor and the fourth transistor are both P-channel metal oxide semiconductor (PMOS) transistors.

As an improvement, the communication device communicates with the electronic device through a dual-to-single wire circuit having a first connection terminal and a second connection terminal and including: an inverter chip and a multi-stage buffer chip, where the multi-stage buffer chip at least includes a first-stage buffer, a second-stage buffer, and a third-stage buffer, an input terminal of the third-stage buffer is configured to receive a TXD signal output by the communications device, an output terminal of the third-stage buffer is connected to an enable terminal of the second-stage buffer, an input terminal of the first-stage buffer, and an input terminal of the inverter chip, an output terminal of the inverter chip is connected to an enable terminal of the first-stage buffer, an output terminal of the first-stage buffer serves as the first connection terminal, an input terminal of the second-stage buffer is connected to the first connection terminal, an output terminal of the second-stage buffer is configured to output a RXD signal to the communications device, and the second connection terminal is connected to the ground; where in the communication mode, the first connection terminal is connected to one of the first input terminal and the second input terminal, the second connection terminal is connected to the other one of the first input terminal and the second input terminal, and the first connection terminal transmits a DATA signal to the electronic device.

As an improvement, the dual-to single wire circuit further includes a thirteenth resistor, a fourteenth resistor, and a fifteenth resistor, one terminal of the thirteenth resistor is connected to the output terminal of the first-stage buffer, and the other terminal of the thirteenth resistor is connected to a power supply voltage; one terminal of the fifteenth resistor is connected to the input terminal of the inverter chip, and the other terminal of the fifteenth resistor is connected to the power supply voltage; and an enable terminal of the third-stage buffer is connected to the supply voltage through the fourteenth resistor.

As an improvement, the electronic system includes a communication assembly, the dual-to-single wire circuit is provided in the communication assembly, and the communication assembly further includes a connector, where the connector includes a first port, a second port, a third port, a fourth port, and a fifth port, where a power supply voltage is provided to the dual-to-single wire circuit through the first port or the fifth port, and a ground voltage is provided to the dual-to-single wire circuit through the fourth port, the second port is connected to the input terminal of the third-stage buffer to receive the TXD signal, and the third port is connected to the output terminal of the first-stage buffer to output the RXD signal.

As an improvement, the communication assembly further includes a sixteenth resistor and a seventeenth resistor, one terminal of the sixteenth resistor is connected to the first port, the other terminal of the sixteenth resistor is connected to a first voltage signal, one terminal of the seventeenth resistor is connected to the fifth port, the other terminal of the seventeenth resistor is connected to a second voltage signal, and a voltage value of the first voltage signal is different from a voltage value of the second voltage signal; and where the resistance value of one of the sixteenth resistor and the seventeen resistor is zero, and the resistance value of the other one of the sixteenth resistor and the seventeen resistor is infinity.

Another aspect of the embodiments of the present disclosure provides a method for controlling an electronic system including providing the electronic system as described in any one of the above embodiments, where the electronic system includes the electronic device and the communication device; where the electronic device at least includes the charging circuit and the switching circuit, where the input terminal of the switching circuit is connected to the first output terminal of the charging circuit, the output terminal of the switching circuit is connected to the power supply of the electronic device, and the connection path between the first output terminal and the power supply is connected or disconnected by controlling the switching circuit; and where during the period in which the switching circuit connects the connection path between the first output terminal and the power supply, the electronic device is in the charging mode, and during the period in which the switching circuit disconnects the connection path between the first output terminal and the power supply, the electronic device is in the communication mode, and where in the communication mode, the communication device is connected to the first input terminal of the charging circuit and the second input terminal of the charging circuit, to communicate with the electronic device through the first input terminal or the second input terminal.

The beneficial effects of the present disclosure are that the present disclosure provides an electronic system and a method for controlling the same, where the electronic system includes an electronic device at least including a charging circuit and a switching circuit; the charging circuit has a first input terminal and a second input terminal which are configured to be connected to an external charging cable, charging device, or communication device, and a first output terminal connected to an input terminal of the switching circuit; an output terminal of the switching circuit is connected to a power supply inside the electronic device; the charging circuit includes a first transistor, a second transistor, a third transistor, and a fourth transistor which are connected in a bridging manner; when the electronic device is charged, a positive terminal and a negative terminal of the external charging cable or charging device are connected to the first input terminal and the second input terminal, respectively, the charging circuit is connective, a charging voltage output from the first output terminal is transmitted to the power supply of the electronic device from the output terminal of the charging circuit; no matter whether the positive terminal is connected to the first input terminal or the second input terminal, the charging voltage can be output from the first output terminal; that is to say, the first input terminal and the second input terminal do not need to be distinguished in terms of positive and negative, the power supply of the electronic device can be charged, as long as one of the first input terminal and the second input terminal is connected to the positive terminal of the external charging cable or charging device, and the other one of the first input terminal and the second input terminal is connected to the negative terminal of the external charging cable or charging device, which avoids a short circuit caused by the misconnection of the positive and negative electrodes, thereby being conducive to improving the usage experience of the electronic device, prolonging the service life of the electronic device, and avoiding the potential safety hazard caused by the reverse connection of the positive and negative electrodes during the charging process.

In addition, after the connection path between the first output terminal and the power supply is disconnected by using the switching circuit, the communication between the electronic device and the external communication device can be enabled by connecting the first input terminal and the second input terminal to the external communication device without disassembling, thereby achieving the functions of serial communication, software burning and the like, and being conducive to avoiding the influence of disassembling on the electronic device and to realizing the communication connection between the electronic device and the external communication device simply and efficiently.

### BRIEF DESCRIPTION OF DRAWINGS

One or more embodiments are exemplarily illustrated by using the figures in the accompanying drawings corresponding thereto, and these exemplary illustrations do not constitute limitations to embodiments. Unless otherwise stated, the figures in the accompanying drawings do not constitute a limitation of scale. In order to more clearly illustrate the embodiments of the present disclosure or the technical solutions in the conventional technologies, the accompanying drawings required to be used in the embodiments will be briefly described below. Obviously, the accompanying drawings in the following description are merely some embodiments of the present disclosure, and for those of ordinary skill in the art, other accompanying drawings may also be obtained according to these accompanying drawings without any creative effort.

FIG. 1 is a structural schematic diagram of an electronic system provided by an embodiment of the present disclosure;

FIG. 2 is a structural schematic diagram of a part of circuits in an electronic device provided by an embodiment of the present disclosure; and

FIG. 3 is a structural schematic diagram of a part of circuits of an electronic system provided by an embodiment of the present disclosure.

### DESCRIPTION OF EMBODIMENTS

It can be seen from the background that the current ways of charging the portable electronic devices need to be improved.

In addition, it is found through analysis that, in the related art, the current wired communication control mostly adopts dual-wire Universal Asynchronous Receiver/Transmitter (UART) communication. In general, the electronic devices have no reserved communication interface and thus cannot be wired upgraded and debugged. If debugging is required, the electronic devices need to be disassembled, which may easily damage the products.

In order to solve the above problems, the embodiments of the present disclosure provides an electronic system and a method for controlling the same, where the electronic system includes an electronic device at least including a charging circuit and a switching circuit; the charging circuit has a first input terminal and a second input terminal which are configured to be connected to an external charging cable, charging device, or communication device, and a first output terminal connected to an input terminal of the switching circuit; an output terminal of the switching circuit is connected to a power supply inside the electronic device; and the power supply of the electronic device can be charged, as long as one of the first input terminal and the second input terminal is connected to the positive terminal of the external charging cable or charging device, and the other one of the first input terminal and the second input terminal is connected to the negative terminal of the external charging cable or charging device, which avoids a short circuit caused by a wrong connection in which the positive terminal is connected to the negative input terminal and the negative terminal is connected to the positive input terminal, thereby being conducive to improving the usage experience of the electronic device, and prolonging the service life of the electronic device.

In addition, after the connection path between the first output terminal and the power supply is disconnected by using the switching circuit, the communication between the electronic device and the external communication device can be enabled by connecting the first input terminal and the second input terminal to the external communication device without disassembling, thereby achieving the functions of serial communication, software burning and the like, avoiding the influence of disassembling on the electronic device, and being conducive to realizing the communication connection between the electronic device and the external communication device simply and efficiently.

In order to make the objectives, technical solutions, and advantages of the present disclosure clearer, various implementations of the present disclosure will be described in detail below in conjunction with the accompanying drawings. However, those of ordinary skill in the art may appreciate that, in the various implementations of the present disclosure, numerous technical details are proposed for the reader to understand the present disclosure better. However, even without these technical details and various variations and modifications based on the following various implementations, the technical solutions claimed in the present disclosure can still be implemented.

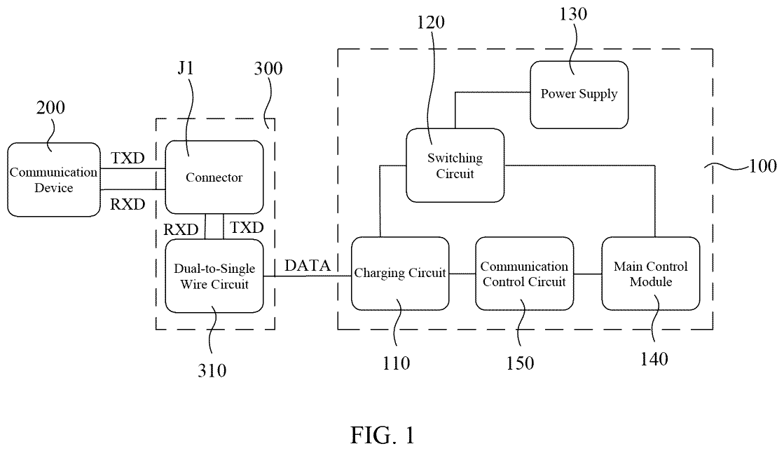

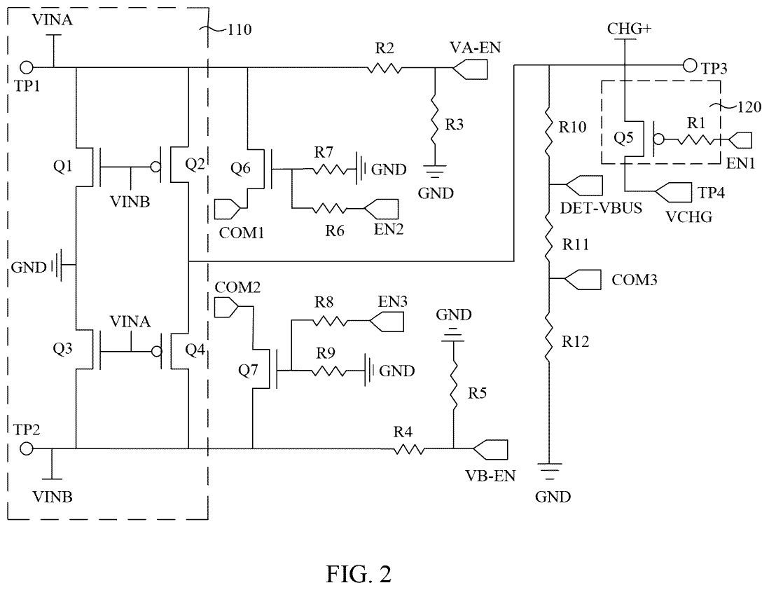

FIG. 1 is a structural schematic diagram of an electronic system provided by an embodiment of the present disclosure. FIG. 2 is a structural schematic diagram of a part of circuits in an electronic device provided by an embodiment of the present disclosure.

Referring to FIG. 1 and FIG. 2, the electronic system provided by the embodiment of the present disclosure includes an electronic device 100. The electronic device 100 may be a portable electronic device. In some embodiments, the electronic device 100 may be either Bluetooth earphones or Bluetooth smart glasses.

The electronic device 100 has two modes, a charging mode and a communication mode. In the charging mode, the electronic device 100 may be connected to an external charging device or a charging cable to charge the electronic device 100. In the communication mode, the electronic device 100 may be connected to a communication device 200 to enable communication between the electronic device 100 and the communication device 200.

The electronic device 100 at least includes a charging circuit 110. In some embodiments, the electronic device 100 has a housing within which the charging circuit 110 may be disposed.

The charging circuit 110 has a first input terminal TP1 and a second input terminal TP2. The first input terminal TP1 and the second input terminal TP2 may be metal contacts configured to dock with POGO PINs on a charging bin, or charging interfaces connected to an external charging cable. In the charging mode, the first input terminal TP1 and the second input terminal TP2 are configured to enable connection with the external charging cable or charging device, which in turn enables charging of the electronic device 100. When the electronic device 100 is charged through the first input terminal TP1 and the second input terminal TP2, one of the first input terminal TP1 and the second input terminal TP2 is connected to a positive terminal of the external charging cable or charging device, and the other one of the first input terminal TP1 and the second input terminal TP2 is connected to a negative terminal of the external charging cable or charging device. In the communication mode, the first input terminal TP1 and the second input terminal TP2 are configured to be connected to the communication device 200, to enable the communication between the electronic device 100 and the external communication device 200, which in turn enables serial communication, software burning and the like.

Referring to FIG. 1 and FIG. 2, the charging circuit 110 further has a first output terminal TP3. In the charging mode, the first output terminal TP3 is configured to output a charging voltage CHG+. In the communication mode, it is possible to determine whether the electronic device 100 is in the communication mode based on a voltage at the first output terminal TP3, which in turn enables the communication between the electronic device 100 and the external communication device 200.

Specifically, referring to FIG. 2, the charging circuit 110 includes a first transistor Q1, a second transistor Q2, a third transistor Q3, and a fourth transistor Q4. A source of the first transistor Q1 is connected to a source of the third transistor Q3, the source of the first transistor Q1 is connected to ground GND, a gate of the first transistor Q1 is connected to a gate of the second transistor Q2, a drain of the first transistor Q1 is connected to a drain of the second transistor Q2, the drain of the first transistor Q1 serves as the first input terminal TP1, a source of the second transistor Q2 is connected to a source of the fourth transistor Q4, the source of the second transistor Q2 serves as the first output terminal TP3, a drain of the third transistor Q3 is connected to a drain of the fourth transistor Q4, the drain of the third transistor Q3 serves as the second input terminal TP2, a gate of the third transistor Q3 is connected to a gate of the fourth transistor Q4, the gate of the third transistor Q3 is connected to the first input terminal TP1, and the gate of the first transistor Q1 is connected to the second input terminal TP2.

In some embodiments, the first transistor Q1 and the third transistor Q3 are both NMOS (N-channel metal oxide semiconductor) transistors, and the second transistor Q2 and the fourth transistor Q4 are both PMOS (P-channel metal oxide semiconductor) transistors.

The operating principle of the charging circuit 110 may be as follows: when the first input terminal TP1 is connected to the positive terminal of the external charging cable or charging device and the second input terminal TP2 is connected to the negative terminal of the charging external cable or the charging device, an input voltage VINA at the first input terminal TP1 is a high-level voltage, an input voltage VINB at the second input terminal TP2 is a low-level voltage, the gate of the first transistor Q1 and the gate of the second transistor Q2 both receive the low-level voltage, the gate of the third transistor Q3 and the gate of the fourth transistor Q4 both receive the high-level voltage, the first transistor Q1 and the fourth transistor Q4 are in a turned-off state, the second transistor Q2 and the third transistor Q3 are in a turned-on state, the input voltage VINA at the first input terminal TP1 is transmitted to the first output terminal T3 through the turned-on second transistor Q2, and the first output terminal T3 outputs the high-level voltage.

When the first input terminal TP1 is connected to the negative terminal of the external charging cable or charging device and the second input terminal TP2 is connected to the positive terminal of the external charging cable or charging device, the input voltage VINA at the first input terminal TP1 is the low-level voltage, the input voltage VINB at the second input terminal TP2 is the high-level voltage, the gate of the first transistor Q1 and the gate of the second transistor Q2 both receive the high-level voltage, the gate of the third transistor Q3 and the gate of the fourth transistor Q4 both receive the low-level voltage, the first transistor Q1 and the fourth transistor Q4 are in a turned-on state, the second transistor Q2 and the third transistor Q3 are in a turned-off state, the input voltage VINB at the second input terminal TP2 is transmitted to the first output terminal TP3 through the turned-on fourth transistor Q4, and the first output terminal TP3 outputs the high-level voltage.

From the above, it can be seen that, no matter whether the positive terminal is connected to the first input terminal TP1 or the second input terminal TP2, the high-level voltage can be output from the first output terminal TP3 as the charging voltage CHG+. That is to say, the first input terminal TP1 and the second input terminal TP2 do not need to be distinguished in terms of positive and negative, a power supply 130 of the electronic device 100 can be charged, as long as one of the first input terminal TP1 and the second input terminal TP2 is connected to the positive terminal of the external charging cable or charging device, and the other one of the first input terminal TP1 and the second input terminal TP2 is connected to the negative terminal of the external charging cable or charging device, which avoids a short circuit caused by a wrong connection in which the positive terminal is connected to the negative input terminal and the negative terminal is connected to the positive input terminal, thereby being conducive to improving the usage experience of the electronic device 100, prolonging the service life of the electronic device 100, and avoiding the potential safety hazard caused by a reverse connection in which the positive terminal is connected to the negative input terminal and the negative terminal is connected to the positive input terminal during the charging process.

Referring to FIG. 1 and FIG. 2, the charging circuit 110 further includes a switching circuit 120, an input terminal of the switching circuit 120 is connected to the first output terminal TP3, an output terminal TP4 of the switching circuit 120 is connected to the power supply 130 of the electronic device 100, and the switching circuit 120 is configured to connect or disconnect a connection path between the first output terminal TP3 and the power supply 130. During a period in which the switching circuit connects the connection path between the first output terminal and the power supply, the electronic device is in the charging mode, and during a period in which the switching circuit disconnects the connection path between the first output terminal and the power supply, the electronic device is in the communication mode. In the charging mode, the charging voltage CHG+ output by the first output terminal TP3 is transmitted to the power supply 130 of the electronic device 100 through the turned-on switching circuit 120 to charge the power supply 130. In the communication mode, the communication device 200 is connected to the first input terminal TP1 and the second input terminal TP2 to communicate with the electronic device 100 through the first input terminal TP1 or the second input terminal TP2.

The switch between the charging state and the communication state of the electronic device 100 is enabled by the switching circuit 120. As such, a charging connection and a communication connection can both be enabled by utilizing the first input terminal TP1 and the second input terminal TP2. The communication connection between the electronic device 100 and the external communication device 200 can be enabled by utilizing a charging port without disassembling, which in turn realizes the functions of serial communication, software burning and the like, and is conducive to avoiding the influence of disassembling on the electronic device 100 and to realizing the communication connection between the electronic device 100 and the external communication device 200 simply and efficiently.

It should be noted that the communication between the communication device 200 and the electronic device 100 mainly refers to performing a wired upgrade on a product and/or debugging a product, for example, performing serial communication control and software burning through the communication connection.

In some embodiments, referring to FIG. 1 and FIG. 2, the electronic device 100 further includes a main control module 140 at least including a first enable terminal EN1. The switching circuit 120 includes a fifth transistor Q5. A gate of the fifth transistor Q5 is connected to the first enable terminal EN1, a source of the fifth transistor Q5 serves as the input terminal of the switching circuit 120, and a drain of the fifth transistor Q5 serves as the output terminal TP4 of the switching circuit 120. During a period in which the gate of the fifth transistor Q5 receives a first enable signal sent from the first enable terminal EN1, the fifth transistor Q5 is in a turned-on state, and during a period in which the gate of the fifth transistor Q5 does not receive the first enable signal sent from the first enable terminal EN1, the fifth transistor Q5 is in a turned-off state. As such, the fifth transistor Q5 is controlled to be turned on or off by controlling the voltage at the gate of the fifth transistor Q5. When the fifth transistor Q5 is in the turned-on state, the electronic device 100 is in the charging mode and the charging voltage CHG+ output by the first output terminal TP3 is transmitted to the output terminal TP4 of the switching circuit 120 through the fifth transistor Q5, and in turn the charging voltage VCGH is transmitted to the power supply 130 of the electronic device 100. Since a transistor may be integrated onto a chip by means of an integrated circuit, using the fifth transistor Q5 as a switch component in the switching circuit 120 is beneficial to reducing the space occupied by the switching circuit 120 in the electronic device 100 and facilitates the application of the switching circuit 120 in a portable electronic device with a small volume such as portable earphones or portable smart glasses.

In some embodiments, the fifth transistor Q5 may be a PMOS transistor, and the first enable signal is a low-level signal. In some other embodiments, the fifth transistor Q5 may also be an NMOS transistor, and the first enable signal is a high-level signal.

In some embodiments, the fifth transistor Q5 may be a PMOS transistor, the switching circuit 120 further includes a first resistor R1, and the gate of the fifth transistor Q5 is connected to the first enable terminal EN1 through the first resistor R1. The first resistor R1 is configured to ensure that the voltage signal output by the first enable terminal EN1 can be matched to the gate of the fifth transistor Q5 and to improve circuit stability, avoiding causing malfunction.

In some embodiments, a resistance value of the first resistor R1 may be 9.5k to 10.5k ohms, for example, 9.5k, 9.8k, 10k, 10.1k, or 10.2k ohms.

In some embodiments, referring to FIG. 1 and FIG. 2, the electronic device 100 further includes the main control module 140 and a communication control circuit 150. The main control module 140 at least includes a second enable terminal EN2, a third enable terminal EN3, a first detection terminal VA-EN, a second detection terminal VB-EN, and a third detection terminal COM3. The first detection terminal VA-EN is connected to the first input terminal TP1, the second detection terminal VB-EN is connected to the second input terminal TP2, and the third detection terminal COM3 is connected to the first output terminal TP3. The third detection terminal COM3 of the main control module 140 is configured to detect the voltage output at the first output terminal TP3, and determine whether the switching circuit 120 is in the turned-on state or the turned-off state according to the voltage output at the third detection terminal COM3. When the switching circuit 120 is in the turned-off state, the voltage detected by the third detection terminal COM3 at the first output terminal TP3 is a communication signal. When the communication signal is detected by the main control module 140, the main control module 140 may control the communication control circuit 150 according to values of voltages detected by the first detection terminal VA-EN and the second detection terminal VB-EN, and specifically, the communication control module may be controlled through the second enable terminal EN2 and the third enable terminal EN3, which in turn enables the electronic device 100 to communicate with the communication device 200.

Referring to FIG. 1 and FIG. 2, the communication control circuit 150 has a second output terminal COM1 and a third output terminal COM2. The communication control circuit 150 includes a sixth transistor Q6 and a seventh transistor Q7. A source of the sixth transistor Q6 serves as the second output terminal COM1, a drain of the sixth transistor Q6 is connected to the first input terminal TP1, and a gate of the sixth transistor Q6 is connected to the second enable terminal EN2. A source of the seventh transistor Q7 serves as the third output terminal COM2, a drain of the seventh transistor Q7 is connected to the second input terminal TP2, and a gate of the seventh transistor Q7 is connected to the third enable terminal EN3. If the third detection terminal COM3 receives the communication signal sent from the first output terminal TP3, the main control module 140 controls the sixth transistor Q6 to be turned on or off according to a signal received by the first detection terminal VA-EN, and controls the seventh transistor Q7 to be turned on or off according to a signal received by the second detection terminal VB-EN.

That is to say, the communication state of the electronic device 100 can be detected by utilizing the main control module 140. When the main control module 140 detects that the electronic device 100 is in the communication state, the first detection terminal VA-EN of the main control module 140 is used to detect the first input terminal TP1, and the second detection terminal VB-EN of the main control module 140 is used to detect the second input terminal TP2, and in turn communication control, debugging or software burning is performed on the circuits within the electronic device 100 through the second output terminal COM1 and the third output terminal COM2.

In some embodiments, referring to FIG. 1 and FIG. 2, one of the first input terminal TP1 and the second input terminal TP2 sends a first signal to the main control module 140 through a respective detection terminal at a same moment. That is to say, data transmission between the electronic device 100 and the communication device 200 is enabled through one of the first input terminal TP1 and the second input terminal TP2. When the electronic device 100 performs data transmission with the communication device 200 through the first input terminal TP1, the first detection terminal VA-EN of the main control module 140 detects the first signal from the first input terminal TP1. When the electronic device 100 performs data transmission with the communication device 200 through the second input terminal TP2, the second detection terminal VB-EN of the main control module 140 detects the first signal from the second input terminal TP2.

During a period in which the first detection terminal VA-EN receives the first signal sent from the first input terminal TP1, the main control module 140 sends a second enable signal from the second enable terminal EN2. During a period in which the gate of the sixth transistor Q6 receives the second enable signal, the sixth transistor Q6 is in a turned-on state, the second output terminal COM1 is connected to the first input terminal TP1, and the first signal is transmitted to the second output terminal COM1 through the sixth transistor Q6, to enable communication between the communication device 200 and the electronic device 100. Meanwhile, the third enable terminal EN3 is in a state in which a third enable signal is not sent. During a period in which the gate of the seventh transistor Q7 does not receive the third enable signal, the seventh transistor Q7 is in a turned-off state, and the third output terminal COM2 is disconnected from the second input terminal TP2.

During a period in which the second detection terminal VB-EN receives the first signal sent from the second input terminal TP2, the main control module 140 sends the third enable signal from the third enable terminal EN3. During a period in which the gate of the seventh transistor Q7 receives the third enable signal, the seventh transistor Q7 is in a turned-on state, the third output terminal COM2 is connected to the second input terminal TP2, and the first signal is transmitted to the third output terminal COM2 through the seventh transistor Q7, to enable communication between the communication device 200 and the electronic device 100. Meanwhile, the second enable terminal EN2 is in a state in which the second enable signal is not sent. During a period in which the gate of the seventh transistor Q6 does not receive the second enable signal, the sixth transistor Q6 is in a turned-off state, and the second output terminal COM1 is disconnected from the first input terminal TP1.

As such, the main control module 140 can determine which one of the first input terminal TP1 and the second input terminal TP2 is a communication port for communication transmission according to a voltage signal of the first input terminal TP1 and a voltage signal of the second input terminal TP2, and in turn control the respective transistor connected to the communication port in the communication control circuit 150, to turn on the transistor connected to the communication port, and further connect the communication port and the respective output port, thereby enabling communication between the electronic device 100 and the communication device 200.

In some embodiments, referring to FIG. 1 and FIG. 2, the electronic device 100 further includes a second resistor R2, a third resistor R3, a fourth resistor R4, and a fifth resistor R5. The first detection terminal VA-EN is connected to the first input terminal TP1 through the second resistor R2, one terminal of the third resistor R3 is connected to the first detection terminal VA-EN, and the other terminal of the third resistor R3 is connected to the ground GND. The second detection terminal VB-EN is connected to the second input terminal TP2 through the fourth resistor R4, one terminal of the fifth resistor R5 is connected to the second detection terminal VB-EN, and the other terminal of the fifth resistor R5 is connected to the ground GND.

A first terminal of the second resistor R2 is connected to the first input terminal TP1, a second terminal of the second resistor R2 is connected to the first detection terminal VA-EN, and the second resistor R2 is configured to ensure that the voltage signal output from the first input terminal TP1 can be matched to the first detection terminal VA-EN of the main control module 140, and to improve circuit stability, avoiding causing malfunction. In some embodiments, a resistance value of the second resistor R2 may be 0.5k to 1.5k ohms, for example, 0.5k, 0.8k, 1k, 1.1k, or 1.2k ohms.

The first terminal of the fourth resistor R4 is connected to the second input terminal TP2, and the second terminal of the fourth resistor R4 is connected to the second detection terminal VB-EN. The fourth resistor R4 is configured to ensure that the voltage signal output from the second input terminal TP2 can be matched to the second detection terminal VB-EN of the main control module 140, and to improve circuit stability, avoiding causing malfunction.

The third resistor R3 serves as a pull-down resistor for the first detection terminal VA-EN. When the first signal is not input to the first input terminal TP1, the signal at the first detection terminal VA-EN is clamped at a low level, to prevent an uncertain state from occurring in the signal line due to floating, which then leads to an undesired state occurring in the system, thereby improving circuit stability, and avoiding causing malfunction. In some embodiments, a resistance value of the third resistor R3 may be 90k to 110k ohms, for example, 95k, 98k, 100k, 101k, or 102k ohms.

The fifth resistor R5 serves as a pull-down resistor for the second detection terminal VB-EN. When the first signal is not input to the second input terminal TP2, the signal at the second detection terminal VB-EN is clamped at a low level, to prevent an uncertain state from occurring in the signal line due to floating, which then leads to an undesired state occurring in the system, thereby improving circuit stability, and avoiding causing malfunction. In some embodiments, a resistance value of the fifth resistor R5 may be 90k to 110k ohms, for example, 95k, 98k, 100k, 101k, or 102k ohms.

In some embodiments, referring to FIG. 1 and FIG. 2, the sixth transistor Q6 and the seventh transistor Q7 are both NMOS transistors.

In some embodiments, referring to FIG. 1 and FIG. 2, the electronic device 100 further includes a sixth resistor R6, a seventh resistor R7, an eighth resistor R8, and a ninth resistor R9. The gate of the sixth transistor Q6 is connected to the second enable terminal EN2 through the sixth resistor R6, one terminal of the seventh resistor R7 is connected to the gate of the sixth transistor Q6, and the other terminal of the seventh resistor R7 is connected to the ground GND. The gate of the seventh transistor Q7 is connected to the third enable terminal EN3 through the eighth resistor R8, one terminal of the ninth resistor R9 is connected to the gate of the seventh transistor Q7, and the other terminal of the ninth resistor R9 is connected to the ground GND.

A first terminal of the sixth resistor R6 is connected to the gate of the sixth transistor Q6, a second terminal of the sixth resistor R6 is connected to the second enable terminal EN2, and the sixth resistor R6 is configured to ensure that the voltage signal output from the second enable terminal EN2 can be matched to the gate of the sixth transistor Q6, and to improve circuit stability, avoiding causing malfunction. In some embodiments, a resistance value of the sixth resistor R6 may be 0.5k to 1.5k ohms, for example, 0.5k, 0.8k, 1k, 1.1k, or 1.2k ohms.

A first terminal of the eighth resistor R8 is connected to the gate of the seventh transistor Q7, a second terminal of the eighth resistor R8 is connected to the third enable terminal EN3, and the eighth resistor R8 is configured to ensure that the voltage signal output from the third enable terminal EN3 can be matched to the gate of the seventh transistor Q7, and to improve circuit stability, avoiding causing malfunction. In some embodiments, a resistance value of the eighth resistor R8 may be 0.5k to 1.5k ohms, for example, 0.5k, 0.8k, 1k, 1.1k, or 1.2k ohms.

The seventh resistor R7 serves as a pull-down resistor for the gate of the sixth transistor Q6. When the second enable terminal EN2 does not output the second enable signal, the gate of the sixth transistor Q6 is clamped at a low level, to prevent an uncertain state from occurring at the gate of the sixth transistor Q6 due to floating, which then leads to an undesired state occurring in the system, thereby improving circuit stability, and avoiding causing malfunction. In some embodiments, a resistance value of the seventh resistor R7 may be 90k to 110k ohms, for example, 95k, 98k, 100k, 101k, or 102k ohms.

The ninth resistor R9 serves as a pull-down resistor for the gate of the seventh transistor Q7. When the third enable terminal EN3 does not output the third enable signal, the gate of the seventh transistor Q7 is clamped at a low level, to prevent an uncertain state from occurring at the gate of the seventh transistor Q7 due to floating, which then leads to an undesired state occurring in the system, thereby improving circuit stability, and avoiding causing malfunction. In some embodiments, a resistance value of the ninth resistor R9 may be 90k to 110k ohms, for example, 95k, 98k, 100k, 101k, or 102k ohms.

In some embodiments, referring to FIG. 1 and FIG. 2, the communication control circuit 150 further includes a tenth resistor R10, an eleventh resistor R11, and a twelfth resistor R12. A first terminal of the tenth resistor R10 is connected to the first output terminal TP3, a second terminal of the tenth resistor R10 is connected to a DET-VBUS, the DET-VBUS is configured to be connected to an IO port of a back-end main control chip to achieve the function of power-on detection, a first terminal of the eleventh resistor R11 is connected to the second terminal of the tenth resistor R10, a second terminal of the eleventh resistor R11 is connected to a first terminal of the twelfth resistor R12, a second terminal of the twelfth resistor R12 is connected to the ground GND, the second terminal of the eleventh resistor R11 is connected to the third detection terminal COM3, and the first output terminal TP3 is connected to the third detection terminal COM3 through the tenth resistor R10 and the eleventh resistor R11.

In some embodiments, a resistance value of the tenth resistor R10 may be 18k to 22k ohms, for example, 18k, 19k, 20k, 21k, or 22k ohms.

In some embodiments, a resistance value of the eleventh resistor R11 may be 75k to 90k ohms, for example, 75k, 78k, 80k, 81k, or 82k ohms.

In some embodiments, a resistance value of the twelfth resistor R12 may be 110k to 130k ohms, for example, 110k, 112k, 115k, 120k, or 122k ohms.

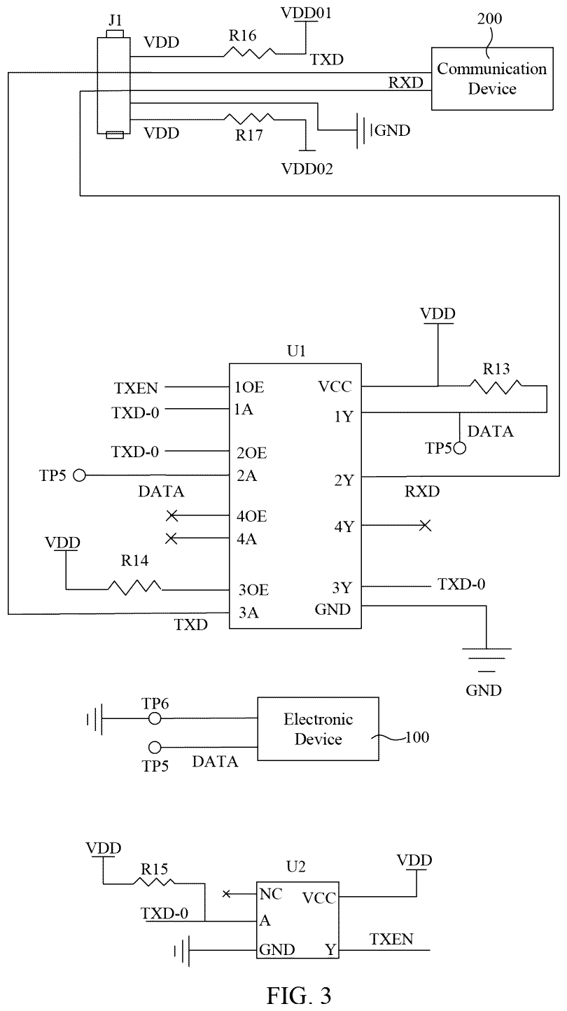

FIG. 3 is a structural schematic diagram of a part of circuits of an electronic system provided by an embodiment of the present disclosure.

In some embodiments, referring to FIG. 1 and FIG. 3, the communication device 200 communicates with the electronic device 100 through a dual-to-single wire circuit 310. The dual-to-single wire circuit 310 has a first connection terminal TP5 and a second connection terminal TP6. The dual-to-single wire circuit 310 includes an inverter chip U2 and a multi-stage buffer chip U1. The multi-stage buffer chip U1 at least includes a first-stage buffer, a second-stage buffer, and a third-stage buffer. An input terminal 3A of the third-stage buffer is configured to receive a TXD signal output by the communications device 200, and an output terminal 3Y of the third-stage buffer is connected to an enable terminal 20E of the second-stage buffer, an input terminal 1A of the first-stage buffer, and an input terminal A of the inverter chip U2. An output terminal Y of the inverter chip U2 is connected to an enable terminal 10E of the first-stage buffer. An output terminal 1Y of the first-stage buffer serves as the first connection terminal TP5, an input terminal 2A of the second-stage buffer is connected to the first connection terminal TP5, an output terminal 2Y of the second-stage buffer is configured to output an RXD signal to the communications device 200, and the second connection terminal TP6 is connected to the ground GND. In the communication mode, the first connection terminal TP5 is connected to one of the first input terminal TP1 and the second input terminal TP2, the second connection terminal TP6 is connected to the other one of the first input terminal TP1 and the second input terminal TP2, and the first connection terminal TP5 transmits a DATA signal to the electronic device 100. The dual-to-single wire circuit 310 may convert a double-end communication port into a single-end communication port and in turn enable communication connection between the electronic device 100 and the external communication device 200 by using the charging port. Enabling the functions of serial communication, software burning and the like through the charging port is beneficial to avoiding the influence on the electronic device 100 due to disassembling, and also is beneficial to enabling communication between the electronic device 100 and the external communication device 200 simply and efficiently.

Specifically, the enable terminals of the buffer chip U1 are each valid at a low level. When the communication device 200 sends the TXD signal to the electronic device 100, the input terminal 3A of the third-stage buffer receives the TXD signal, an enable terminal 30E of the third-stage buffer is at a low level, the output terminal 3Y of the third-stage buffer outputs a TXD-0 signal, the TXD-0 signal is transmitted to the input terminal A of the inverter chip U2, and a TXEN signal is output from the output terminal Y of the inverter chip U2. At this time, the TXD signal is a high-level signal, the TXD-0 signal is a high-level signal, the TXEN signal is a low-level signal, and the TXEN signal is transmitted to the enable terminal 10E of the first-stage buffer. The TXD-0 signal is input to the input terminal 1A of the first-stage buffer, and the output terminal 1Y of the first-stage buffer outputs the DATA signal, and the DATA signal is transmitted to the electronic device 100 through either the first input terminal TP1 or the second input terminal TP2.

It should be noted that the DATA signal is the first signal in the above-mentioned embodiments.

When the communication device 200 receives the RXD signal output by the electronic device 100, the electronic device 100 sends the DATA signal through either the first input terminal TP1 or the second input terminal TP2, the DATA signal is transmitted from the first connection terminal TP5 to the input terminal 2A of the second-stage buffer. The input terminal A of the inverter chip U2 is set to be at a low level, and accordingly, the TXEN signal output by the output terminal Y of the inverter chip U2 is a high-level signal, and the TXD-0 signal is a low-level signal. Therefore, the output terminal 2Y of the second-stage buffer can output the RXD signal, and the communication device 200 receives the RXD signal.

In some embodiments, the model of the inverter chip U2 may be 74HClG04.

In some embodiments, the multi-stage buffer chip U1 may be a four-stage buffer chip. In some examples, the model of the four-stage buffer chip U1 may be 74HCl26.

In some embodiments, referring to FIG. 3, the dual-to-single wire circuit 310 further includes a thirteenth resistor R13, a fourteenth resistor R14, and a fifteenth resistor R15. One terminal of the thirteenth resistor R13 is connected to the output terminal 1Y of the first-stage buffer, and the other terminal of the thirteenth resistor R13 is connected to a power supply voltage VDD. One terminal of the fifteenth resistor R15 is connected to the input terminal A of the inverter chip U2, and the other terminal of the fifteenth resistor R15 is connected to the power supply voltage VDD. The enable terminal of the third-stage buffer is connected to the power supply voltage VDD through the fourteenth resistor R14.

The thirteenth resistor R13 is used as a pull-up resistor for the first connection terminal TP5. In some embodiments, a resistance value of the thirteenth resistor R13 may be 1.8k to 2.4k ohms, for example, 1.8k, 1.9k, 2k, 2.1k, or 2.2k ohms.

A first terminal of the fourteenth resistor R14 is connected to the power supply voltage VDD, and a second terminal of the fourteenth resistor R14 is connected to the enable terminal 30E of the third-stage buffer. In some embodiments, a resistance value of the fourteenth resistor R14 may be 8k to 12k ohms, for example, 8k, 9k, 10k, 11k, or 12k ohms. The fourteenth resistor R14 enables the enable terminal 30E of the third stage buffer to be in a low-level state.

In some embodiments, a resistance value of the fifteenth resistor R15 may be 0.5k to 1.5k ohms, for example, 0.5k, 0.8k, 1k, 1.1k, or 1.2k ohms. When the TXD signal is invalid, the fifteenth resistor R15 enables the input terminal A of the inverter chip U2 to be at a low level, and enables the TXD-0 signal received by the enable terminal 20E of the second stage buffer to be at a low level.

In some embodiments, the electronic system includes a communication assembly 300. The dual-to-single wire circuit 310 is provided in the communication assembly 300. The communication assembly 300 further includes a connector J1. The connector J1 includes a first port, a second port, a third port, a fourth port, and a fifth port. The power supply voltage VDD is provided to the dual-to-single wire circuit 310 through the first port or the fifth port, and a ground voltage is provided to the dual-to-single wire circuit 310 through the fourth port, the second port is connected to the input terminal 3A of the third-stage buffer for receiving the TXD signal, and the third port is connected to the output terminal 1Y of the first-stage buffer for outputting the RXD signal. The advantages of providing the power supply voltage VDD to the dual-to-single wire circuit 310 through the first port or the fifth port are as follows: the port for providing the power supply voltage VDD may be selected according to actual requirements of the power supply voltage VDD in the dual-to-single wire circuit 310, which is beneficial to improving application flexibility of the communication assembly 300 in different scenarios.

In some embodiments, the communication assembly 300 may be a connection circuit board independent from the electronic device 100 and the communication device 200.

In some embodiments, the communication assembly 300 further includes a sixteenth resistor R16 and a seventeenth resistor R17. One terminal of the sixteenth resistor R16 is connected to the first port, the other terminal of the sixteenth resistor R16 is connected to a first voltage signal VDD01, one terminal of the seventeenth resistor R17 is connected to the fifth port, the other terminal of the seventeenth resistor R17 is connected to a second voltage signal VDD02, and a voltage value of the first voltage signal VDD01 is different from a voltage value of the second voltage signal VDD02. A resistance value of one of the sixteenth resistor R16 and the seventeen resistor is zero, and a resistance value of the other one of the sixteenth resistor R16 and the seventeen resistor is infinity.

For example, the voltage value of the first voltage signal VDD01 may be 3V, and the voltage value of the second voltage signal VDD02 may be 5V. When the power supply voltage VDD required by the dual-to-single wire circuit 310 is 3V, the resistance value of the sixteenth resistor R16 is set to be zero, the resistance value of the seventeenth resistor R17 is set to be infinity, and the power supply voltage VDD of 3V can be provided to the dual-to-single wire circuit 310 through the first port. When the power supply voltage VDD required by the dual-to-single wire circuit 310 is 5V, the resistance value of the sixteenth resistor R16 is set to infinity, the resistance value of the seventeenth resistor R17 is set to zero, and the power supply voltage VDD of 5V may be provided to the dual-to-single wire circuit 310 through the fifth port.

In the electronic system provided by the above embodiments, the power supply of the electronic device can be charged, as long as one of the first input terminal and the second input terminal is connected to the positive terminal of the external charging cable or charging device, and the other one of the first input terminal and the second input terminal is connected to the negative terminal of the external charging cable or charging device, which avoids a short circuit caused by a wrong connection in which the positive terminal is connected to the negative input terminal and the negative terminal is connected to the positive input terminal, thereby being conducive to improving the usage experience of the electronic device, prolonging the service life of the electronic device, and avoiding the potential safety hazard caused by a reverse connection in which the positive terminal is connected to the negative input terminal and the negative terminal is connected to the positive input terminal during the charging process. In addition, the conditions for use in the low-voltage circuit are satisfied, and the low-voltage circuit herein refers to a power supply circuit with a supply voltage equal to or less than 5V, thereby avoiding a phenomenon of the power supply not being satisfied due to a voltage drop caused by the characteristics of a transistor. In addition, after the connection path between the first output terminal and the power supply is disconnected by using the switching circuit, the communication between the electronic device and the external communication device can be enabled by connecting the first input terminal and the second input terminal to the external communication device without disassembling, which in turn enables the functions of serial communication, software burning and the like, and is conducive to avoiding the influence of disassembling on the electronic device and to realizing the communication connection between the electronic device and the external communication device simply and efficiently.

Another aspect of the embodiments of the present disclosure further provides a method for controlling an electronic system. It should be noted that the method for controlling an electronic system is used to control the electronic system provided by the above embodiments of the present disclosure, in the above embodiments, the method for controlling the electronic system has been described in detail, and the method for controlling an electronic system provided by the embodiments of the present disclosure may refer to the above embodiments, and the parts that are the same with or corresponding to those in the above embodiments are not described herein again.

The method for controlling the electronic system includes providing an electronic system as described in any one of the above embodiments of the present disclosure. The electronic system includes an electronic device and a communication device. The electronic device at least includes a charging circuit and a switching circuit. An input terminal of the switching circuit is connected to a first output terminal of the charging circuit, an output terminal of the switching circuit is connected to a power supply of the electronic device, and the switching circuit is controlled to connect or disconnect a connection path between the first output terminal and the power supply. During a period in which the switching circuit connects the connection path between the first output terminal and the power supply, the electronic device is in a charging mode, and during a period in which the switching circuit disconnects the connection path between the first output terminal and the power supply, the electronic device is in a communication mode. In the communication mode, the communication device is connected to the first input terminal of the charging circuit and the second input terminal of the charging circuit to communicate with the electronic device through the first input terminal or the second input terminal.

By controlling the electronic system, charging and communication can be enabled by using the charging port of the electronic device, the communication between the electronic device and the external communication device can be enabled by connecting the first input terminal and the second input terminal to the external communication device without disassembling, which in turn enables the functions of serial communication, software burning and the like, and is conducive to avoiding the influence of disassembling on the electronic device and to realizing the communication between the electronic device and the external communication device simply and efficiently.

It may be understood by those of ordinary skill in the art that the above implementations are specific embodiments for implementing the present disclosure. However, in practical applications, various changes may be made to them in terms of form and detail without departing from the spirit and scope of the present disclosure. Any one of skill in the art can make respective changes and modifications without departing from the spirit and scope of the present disclosure, and therefore the protection scope of the present disclosure shall be determined according to the scope defined by the claims.

What is claimed is:

1. An electronic system, comprising:
an electronic device at least comprising:
a charging circuit having a first input terminal, a second input terminal, and a first output terminal, and comprising a first transistor, a second transistor, a third transistor, and a fourth transistor, wherein a source of the first transistor is connected to a source of the third transistor, the source of the first transistor is connected to ground, a gate of the first transistor is connected to a gate of the second transistor, a drain of the first transistor is connected to a drain of the second transistor, the drain of the first transistor serves as the first input terminal, a source of the second transistor is connected to a source of the fourth transistor, the source of the second transistor serves as the first output terminal, a drain of the third transistor is connected to a drain of the fourth transistor, the drain of the third transistor serves as the second input terminal, a gate of the third transistor is connected to a gate of the fourth transistor, the gate of the third transistor is connected to the first input terminal, and the gate of the first transistor is connected to the second input terminal; and
a switching circuit having an input terminal connected to the first output terminal and an output terminal connected to a power supply of the electronic device, wherein the switching circuit is configured to connect or disconnect a connection path between the first output terminal and the power supply;
wherein during a period in which the switching circuit connects the connection path between the first output terminal and the power supply, the electronic device is in a charging mode, and during a period in which the switching circuit disconnects the connection path between the first output terminal and the power supply, the electronic device is in a communication mode; and
wherein in the communication mode, a communication device is connected to the first input terminal and the second input terminal to communicate with the electronic device through the first input terminal or the second input terminal.

2. The electronic system as described in claim 1, wherein the electronic device further comprises a main control module at least comprising a first enable terminal;
wherein the switching circuit comprises a fifth transistor, a gate of the fifth transistor is connected to the first enable terminal, a source of the fifth transistor serves as the input terminal of the switching circuit, and a drain of the fifth transistor serves as the output terminal of the switching circuit; and
wherein during a period in which the gate of the fifth transistor receives a first enable signal sent from the first enable terminal, the fifth transistor is in a turned-on state, and during a period in which the gate of the fifth transistor does not receive the first enable signal sent from the first enable terminal, the fifth transistor is in a turned-off state.

3. The electronic system as described in claim 2, wherein the switching circuit further comprises a first resistor, and the gate of the fifth transistor is connected to the first enable terminal through the first resistor.

4. The electronic system as described in claim 1,
wherein the electronic device further comprises a main control module;
wherein the main control module at least has a second enable terminal, a third enable terminal, a first detection terminal, a second detection terminal, and a third detection terminal, the first detection terminal is connected to the first input terminal, the second detection terminal is connected to the second input terminal, and the third detection terminal is connected to the first output terminal;
wherein the electronic device further comprises a communication control circuit having a second output terminal and a third output terminal, and the communication control comprises:
a sixth transistor, wherein a source of the sixth transistor serves as the second output terminal, a drain of the sixth transistor is connected to the first input terminal, and a gate of the sixth transistor is connected to the second enable terminal; and
a seventh transistor, wherein a source of the seventh transistor serves as the third output terminal, a drain of the seventh transistor is connected to the second input terminal, and a gate of the seventh transistor is connected to the third enable terminal; and
wherein when the third detection terminal receives a communication signal sent from the first output terminal, the main control module controls the sixth transistor to be turned on or off according to a signal received by the first detection terminal, and controls the seventh transistor to be turned on or off according to a signal received by the second detection terminal.

5. The electronic system as described in claim 4, wherein
one of the first input terminal or the second input terminal sends a first signal to the main control module through a respective detection terminal at a same moment;
during a period in which the first detection terminal receives the first signal sent from the first input terminal, the main control module sends a second enable signal from the second enable terminal, and during a period in which the gate of the sixth transistor receives the second enable signal, the sixth transistor is in a turned-on state, and the second output terminal is connected to the first input terminal to enable communication between the communication device and the electronic device;
during a period in which the second detection terminal receives the first signal sent from the second input terminal, the main control module sends a third enable signal from the third enable terminal, and during a period in which the gate of the seventh transistor receives the third enable signal, the seventh transistor is in a turned-on state, and the third output terminal is connected to the second input terminal to enable the communication between the communication device and the electronic device; and
during a period in which the gate of the sixth transistor does not receive the second enable signal, the sixth transistor is in a turned-off state, and during a period in which the gate of the seventh transistor does not receive the third enable signal, the seventh transistor is in a turned-off state.

6. The electronic system as described in claim 4, further comprising a second resistor, a third resistor, a fourth resistor, and a fifth resistor,
wherein the first detection terminal is connected to the first input terminal through the second resistor, one terminal of the third resistor is connected to the first detection terminal, and the other terminal of the third resistor is connected to the ground; and
wherein the second detection terminal is connected to the second input terminal through the fourth resistor, one terminal of the fifth resistor is connected to the second detection terminal, and the other terminal of the fifth resistor is connected to the ground.

7. The electronic system as described in claim 4, further comprising: a sixth resistor, a seventh resistor, an eighth resistor, and a ninth resistor,
wherein the gate of the sixth transistor is connected to the second enable terminal through the sixth resistor, one terminal of the seventh resistor is connected to the gate of the sixth transistor, and the other terminal of the seventh resistor is connected to the ground; and
wherein the gate of the seventh transistor is connected to the third enable terminal through the eighth resistor, one terminal of the ninth resistor is connected to the gate of the seventh transistor, and the other terminal of the ninth resistor is connected to the ground.

8. The electronic system as described in claim 4, wherein the communication control circuit further comprises a tenth resistor, an eleventh resistor, and a twelfth resistor,
a first terminal of the tenth resistor is connected to the first output terminal, a first terminal of the eleventh resistor is connected to a second terminal of the tenth resistor, a second terminal of the eleventh resistor is connected to a first terminal of the twelfth resistor, a second terminal of the twelfth resistor is connected to the ground, the second terminal of the eleventh resistor is connected to the third detection terminal, and the first output terminal is connected to the third detection terminal through the tenth resistor and the eleventh resistor.

9. The electronic system as described in claim 4, wherein the sixth transistor and the seventh transistor are both N-channel metal oxide semiconductor (NMOS) transistors.

10. The electronic system as described in claim 1, wherein the first transistor and the third transistor are both NMOS transistors, and the second transistor and the fourth transistor are both P-channel metal oxide semiconductor (PMOS) transistors.

11. The electronic system as described in any one of claim 1, wherein the communication device communicates with the electronic device through a dual-to-single wire circuit having a first connection terminal and a second connection terminal and comprising:
an inverter chip and a multi-stage buffer chip, wherein the multi-stage buffer chip at least comprises a first-stage buffer, a second-stage buffer, and a third-stage buffer, an input terminal of the third-stage buffer is configured to receive a transmit data (TXD) signal output by the communications device, an output terminal of the third-stage buffer is connected to an enable terminal of the second-stage buffer, an input terminal of the first-stage buffer, and an input terminal of the inverter chip, an output terminal of the inverter chip is connected to an enable terminal of the first-stage buffer, an output terminal of the first-stage buffer serves as the first connection terminal, an input terminal of the second-stage buffer is connected to the first connection terminal, an output terminal of the second-stage buffer is configured to output a receive data (RXD) signal to the communications device, and the second connection terminal is connected to the ground;
wherein in the communication mode, the first connection terminal is connected to one of the first input terminal and the second input terminal, the second connection terminal is connected to the other one of the first input terminal and the second input terminal, and the first connection terminal transmits a DATA signal to the electronic device.

12. The electronic system as described in claim 11, wherein the dual-to single wire circuit further comprises a thirteenth resistor, a fourteenth resistor, and a fifteenth resistor,
one terminal of the thirteenth resistor is connected to the output terminal of the first-stage buffer, and the other terminal of the thirteenth resistor is connected to a power supply voltage;
one terminal of the fifteenth resistor is connected to the input terminal of the inverter chip, and the other terminal of the fifteenth resistor is connected to the power supply voltage; and
an enable terminal of the third-stage buffer is connected to the supply voltage through the fourteenth resistor.

13. The electronic system as described in claim 11, wherein the electronic system comprises a communication assembly, the dual-to-single wire circuit is provided in the communication assembly, and the communication assembly further comprises a connector,
wherein the connector comprises a first port, a second port, a third port, a fourth port, and a fifth port, wherein a power supply voltage is provided to the dual-to-single wire circuit through the first port or the fifth port, and a ground voltage is provided to the dual-to-single wire circuit through the fourth port, the second port is connected to the input terminal of the third-stage buffer to receive the TXD signal, and the third port is connected to the output terminal of the first-stage buffer to output the RXD signal.

14. The electronic system as described in claim 13, wherein the communication assembly further comprises a sixteenth resistor and a seventeenth resistor,
one terminal of the sixteenth resistor is connected to the first port, the other terminal of the sixteenth resistor is connected to a first voltage signal, one terminal of the seventeenth resistor is connected to the fifth port, the other terminal of the seventeenth resistor is connected to a second voltage signal, and a voltage value of the first voltage signal is different from a voltage value of the second voltage signal; and
wherein the resistance value of one of the sixteenth resistor and the seventeen resistor is zero, and the resistance value of the other one of the sixteenth resistor and the seventeen resistor is infinity.

15. A method for controlling an electronic system, comprising providing the electronic system as described in any one of claim 1,
wherein the electronic system comprises the electronic device and the communication device;
wherein the electronic device at least comprises the charging circuit and the switching circuit, wherein the input terminal of the switching circuit is connected to the first output terminal of the charging circuit, the output terminal of the switching circuit is connected to the power supply of the electronic device, and the connection path between the first output terminal and the power supply is connected or disconnected by controlling the switching circuit; and
wherein during the period in which the switching circuit connects the connection path between the first output terminal and the power supply, the electronic device is in the charging mode, and during the period in which the switching circuit disconnects the connection path between the first output terminal and the power supply, the electronic device is in the communication mode, and wherein in the communication mode, the communication device is connected to the first input terminal of the charging circuit and the second input terminal of the charging circuit, to communicate with the electronic device through the first input terminal or the second input terminal.
